(19) United States
(12) Patent Application Publication
(10) Pub. No.: US 2007/0239480 A1
(43) Pub. Date: Oct. 11, 2007

(54) Subscription-based catastrophe-triggered medical services facilitation method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/394,350

(22) Filed: Mar. 30, 2006

(51) Int. Cl. G06Q 10/00; G06Q 50/00

(52) U.S. Cl. 705/2; 705/75

(57) ABSTRACT

Consideration-based private civil security subscriptions are accepted (101) from subscribers with respect to providing civilly-catastrophic event-based access to at least one life-sustaining medical service. That life-sustaining medical service is then maintained (102) pending a need to permit subscription-based access to the life-sustaining medical service in the event of a catastrophic event. The nature of the subscribed-to life-sustaining medical service can vary with the needs or requirements of a given application setting but may comprise one or more of a consumable life-sustaining medical service, a non-consumable life-sustaining medical service, a venue where such services can be securely offered, transportation to effect the above-mentioned access, and/or rescue, to note but a few useful examples. By one approach, these subscriptions may also relate to offering civilly-catastrophic event-based access to one or more life-enhancing medical services (as versus life-sustaining) (including both consumable and non-consumable life-enhancing medical services).

### RELATED APPLICATIONS

This comprises a continuation-in-part of an earlier filed patent application entitled SUBSCRIPTION-BASED PRIVATE CIVIL SECURITY FACILITATION METHOD as filed on Mar. 17, 2006 and bearing attorney's docket number 8379/87561, the contents of which are fully incorporated herein by this reference.

### TECHNICAL FIELD

This invention relates generally to providing medical services.

### BACKGROUND

Modern medical services offer a wide and ever-increasing variety of powerful diagnostic and treatment opportunities. Such medical services range from being life-enhancing to offering prolonged sustainment of life itself. A typical modern society offers such medical services though a variety of access means that, in turn, are typically based upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable consumables and other health care needs from source to medical services provider and/or consumer;

communications infrastructure such as telephones, television, radio, and the Internet that facilitate the inexpensive and rapid sharing of news, advice, information, medical records, medical diagnostic test data, and experimental or clinical findings, to note but a few relevant examples;

the totality of civil services such as police services, fire fighting services, ambulance services, and so forth that facilitate a sufficient degree of order and predictability to, in turn, permit the complex series of inter-related actions that modern society in general requires in order to operate; and

a current inventory of locally-available consumable medical services items that depends highly upon a just-in-time delivery apparatus that, in turn, depends heavily upon the aforementioned accoutrements of a modern society.

As powerful as the machinery of modern life appears, however, modern citizens are today perhaps more at risk of experiencing a serious disruption in their ability to receive timely and meaningful medical attention en mass than is generally perceived. Providing effective medical services in general requires a lot of things to all operate, more or less, correctly. To put it another way, a serious disruption to any significant element of civilized infrastructure can produce catastrophic results for a broad swath of a given civil entity. Any number of natural and/or human-caused events can greatly disrupt society's infrastructure and corresponding ability to provide one or more medical services including, but not limited to, emergency medical services, acute medical services, chronic medical services, and so forth.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs. To a large extent one may reasonably argue that governments have forsaken their responsibility to design, fund, implement, or even discuss an effective civil defense program capable of protecting large segments of their populations. This unfortunately includes sufficient medical services to readily accommodate surge capacity needs as may attend a civilly-catastrophic event.

Such insights, of course, are not particularly new. Attempting to take responsible action, however, to reasonably ensure one's own access to medical services in times of great need will typically be partially or fully frustrated by the utter breadth, cost, and complexity of modern medical services on the one hand, and the lack of sufficient available critical resources in the face of a civilly-catastrophic event on the other hand. In general, only the most extravagantly affluent, the politically connected, or members of the medical community may have some reasonable expectation of being able to access adequate medical services during such times of great need.

### BRIEF DESCRIPTION OF THE DRAWINGS

The above needs are at least partially met through provision of the subscription-based catastrophe-triggered medical services facilitation method described in the following detailed description, particularly when studied in conjunction with the drawings, wherein:

FIG. 1 comprises a flow diagram as configured in accordance with various embodiments of the invention;

FIG. 2 comprises a schematic block diagram view as configured in accordance with various embodiments of the invention;

FIG. 3 comprises a schematic block diagram as configured in accordance with various embodiments of the invention; and

FIG. 4 comprises a top plan block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, consideration-based private civil security subscriptions are accepted from subscribers with respect to providing civilly-catastrophic event-based access to at least one life-sustaining medical service. That life-sustaining medical service is then maintained pending a need to permit subscription-based access to the life-sustaining medical service in the event of a catastrophic event.

The nature of the subscribed-to life-sustaining medical service can vary with the needs or requirements of a given application setting but may comprise one or more of a consumable life-sustaining medical service, a non-consumable life-sustaining medical service, a venue where such services can be securely offered, transportation to effect the above-mentioned access, and/or rescue, to note but a few useful examples. By one approach, these subscriptions may also relate to offering civilly-catastrophic event-based access to one or more life-enhancing medical services (as versus life-sustaining) (including both consumable and non-consumable life-enhancing medical services).

These steps are facilitated without dependency upon governmental oversight, participation, or control. The particular medical services provided can vary with the needs and requirements of the authorized beneficiaries. Importantly, via these teachings an individual can take important steps to bring a considerably improved measure of security into their lives, knowing that, should a civilly-catastrophic event indeed be visited upon them, they will have extraordinary access to one or more life-sustaining medical services that are critical to human life.

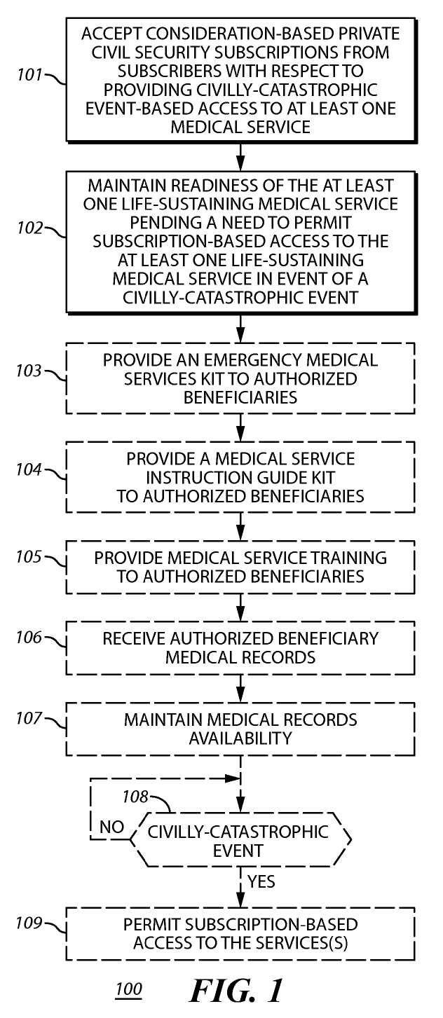

These and other benefits may become clearer upon making a thorough review and study of the following detailed description. Referring now to the drawings, and in particular to FIG. 1, these teachings provide generally for accepting 101 consideration-based private civil security subscriptions from subscribers with respect to providing civilly-catastrophic event-based access to at least one medical service (or, if desired, to a plurality of different kinds and/or categories of medical services). By one approach this medical service comprises a life-sustaining medical service; i.e., a medical service that is substantially essential to sustaining an individual's human life and without which the patient will likely die of an untreated disease, physical condition, injury, or the like. Such life-sustaining medical services can comprise one or more of:
an acute need medical service;
a chronic need medical service;
a diagnostic medical service;
a medical treatment;
a medical procedure;
a life support service (such as, but not limited to, respiration, dialysis, and so forth);
at least a portion of a series of related medical treatments (such as, but not limited to, radiation therapy or chemotherapy and the like);
an apparatus-based medical service;
a human-skills-based medical service; and
extended care accommodations;
   to note but a few salient examples.

If desired, these medical services can also comprise one or more life-enhancing medical services; i.e., a medical service that, while not essential to sustaining human life, nevertheless provides comfort, augmented physical capability to overcome or ameliorate a disability, relief from non-life threatening conditions, injuries, sensitivities, and the like, and so forth. Such life-sustaining medical services can comprise one or more of:
an acute need medical service;
a chronic need medical service;
a diagnostic medical service;
a medical treatment;
a medical procedure;
at least a portion of a series of related medical treatments (such as, but not limited to, dermal abrasion, physical therapy, and the like);
an apparatus-based medical service;
a human-skills-based medical service; and
extended care accommodations;
   to note but a few salient examples.

These medical services can comprise either or both of a material that is at least substantially consumed during ordinary usage (such as, for example, blood, plasma, drugs, dressings, syringes, and so forth) and/or a material that is not substantially consumed during ordinary usage (such as, for example, surgical instruments, respirators, magnetic resonance imaging equipment, and so forth). As noted above, these medical services can also comprise proficient corresponding human resources. Relevant examples include, but are certainly not limited to, physicians, surgeons, medical technicians, radiologists, laboratory technicians, nurses, emergency response technicians, pharmacists, chiropractors, opticians, anesthesiologists, psychologists, and naturopathic practitioners, to note but a few.

This right of access can pertain, if desired, to a predetermined quantity of the medical service. For example, a given subscription can relate to providing access to a one year's supply of the at least one medical service for a given individual, number of individuals, or the like. As another example, a given subscription might pertain to a specific course of treatment such as a series of radiation treatments. In this case, the subscription-based right of access might correspond to a particular starting and ending date during which the corresponding subscription beneficiary might be undergoing that treatment series using normally available medical services resources. By this approach, this individual will be better assured of being able to complete this particular course of treatment, once begun, notwithstanding a civilly-catastrophic event that would otherwise likely prevent uninterrupted provision of the course of treatment.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights regarding access to the at least one medical service);

non-transferable rights of access (as may occur when the subscription, by its terms and conditions, prohibits transfer of the right of access to the at least one medical service from a first named beneficiary to another);

transferable rights of access (as may occur when the subscription, by its terms and conditions, permits conditional or unconditional transfer of the right of access to the at least one medical service from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the at least one medical service); and/or

non-ownership-based rights of access (as may occur when the subscription, by its terms and conditions, establishes the aforementioned right of access via, for example, a lease, rental, or borrowing construct).

If desired, a plurality of differentiated subscription opportunities can be offered in this regard. This plurality of differentiated subscription opportunities can correspond, for example, to providing access to differing medical service supplies. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing medical services that, though medically viable, are economically selected while another subscription might provide for medical services that are more costly and in turn reflect, for example, a wider variety of choices within a given category of resource.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to one or more medical services in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of civil infrastructure impairment or other measurable impact of choice.

As used herein, “civilly-catastrophic event” will be understood to refer to an event that substantially and materially disrupts a society's local, regional, and/or national infrastructure and ability to provide in ordinary course for the at least one medical service that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, an ice age, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

This process 100 then provides for maintaining 102 readiness of the at least one medical service pending a need to permit subscription-based access to the medical service(s) in response to the occurrence of a catastrophic event. This, of course, can comprise maintaining the medical service(s) on behalf of the subscriber and/or on behalf of another authorized beneficiary. The specifics of such maintenance will of course vary with respect to the nature of the resource or resources being maintained.

As one example, when the resource (or resources) comprise one or more predetermined consumable medical supplies, maintaining the resource can comprise acquiring the at least one predetermined consumable medical supply to thereby provide acquired medical supplies and then storing those acquired medical supplies to thereby provide stored medical supplies that are held on behalf of the corresponding authorized beneficiaries pending a need to access those stored medical supplies in the event of a triggering civilly-catastrophic event. These acquisition and storing steps can further comprise, if desired, acquiring and storing non-consumable medical supplies on behalf of specific beneficiaries.

Acquisition of such items can be achieved through any of a variety of means. By one approach the items may be procured on the open market. By another approach the items may be purchased or otherwise acquired from third parties via private negotiations. By yet another approach the entity that provides and accepts these subscriptions may itself create (through manufacturing, farming, or the like) the items of interest. In some cases the acquired item may comprise a staple of ordinary commerce. In other cases the acquired item may be unique and/or proprietary to the acquiring/storing entity.

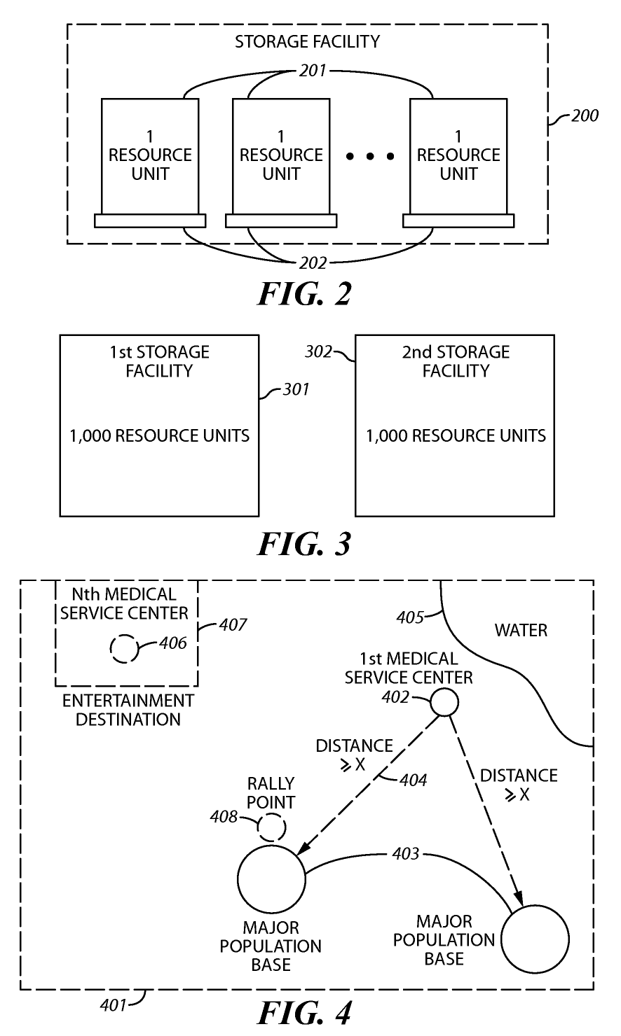

With momentary reference to FIG. 2, by one approach such storage occurs through use of one or more storage facilities 200 that are owned or controlled by the subscription accepting entity. Any suitable storage facility may be used for this purpose with examples comprising (but not being limited to) above ground man-made shelters, below ground or below water facilities (including purposefully excavated facilities, natural caverns, and so forth), and water borne facilities (such as barges and the like). Each such storage facility 200 will likely serve to store the resources as correspond to a plurality of authorized beneficiaries. By one approach such resources are stored in the aggregate. By another approach, or in combination with an aggregated approach, some or all of the acquired necessities are stored in subscriber-based bundles 201. For example, each such bundle 201 can comprise a one year supply of all acquired items for a single authorized beneficiary. As another example, such a bundle 201 could comprise a one year supply of all acquired items as are intended for a family of four authorized beneficiaries. These supplies could represent an assortment of medical services items that might be generally held in reserve for a given individual based upon general potential medical services needs for the beneficiary population and/or might comprise medical services items that are particularly intended for a specific given recipient based upon their specific personal medical services needs or anticipated needs.

Other possibilities of course exist. For example, a single authorized beneficiary may have a first bundle comprised of staple medical services items that are acquired and stored for all beneficiaries and a second bundle comprised of custom items that are specifically and uniquely acquired for this particular beneficiary or class of beneficiaries (such as beneficiaries who all share a common ailment, sensitivity, medical condition, or the like).

The bundle 201 itself can be realized via any of a wide variety of encapsulating or restraining mechanisms. For example, a tarp and tie-downs can be used to segregate the medical services items and form the described bundle. As another example, discrete storage cabinets formed of wood, metal, plastic, canvas, or other material of choice could be employed for this purpose. Shrink wrap materials could also be employed in this regard. In addition, if desired, these bundles 201 can be individually palletized (i.e., each placed upon and optionally secured to a pallet 202). Palletization, in turn, will permit ready and efficient movement of such bundles 201 to, about, or from a given storage facility 200 and/or delivery of such a bundle to an authorized beneficiary when such delivery comprises the desired form of granting access to such resources.

The use of such bundles (and particularly the bundling of staple medical services items in a manner calculated to provide at least a minimum level of medical services support to a predetermined number of authorized beneficiaries for at least a predetermined period of time) provides highly leveragable resource allocation opportunities as well. For example, and referring now momentarily to FIG. 3, a first storage facility 301 may contain 1,000 such storage units while a second storage facility 302 may contain an additional 1,000 such storage units. By treating such storage units, at least in part, as being fungible with one another, such resources can be made available to authorized beneficiaries in time of need by accessing a storage facility that is positioned to provide the earliest relief to the beneficiaries rather than by necessarily requiring all beneficiaries to only access their resources from a specific pre-ordained facility.

Referring again to FIG. 1, maintaining 102 the medical service in such a context can further optionally comprise maintaining the utility of the stored medical services items. This can comprise, for example, monitoring the usability of perishable items and replacing such items on a corresponding schedule. As another simple illustration this step can comprise holding certain items in deep refrigeration or in other special storage conditions (such as while frozen, heated, humidified, de-humidified, and so forth) as may suit the proper maintenance of such items.

Such maintenance can also optionally comprise making adjustments to the stored medical services items to reflect dynamically changing circumstances as occur during the consideration-based private civil security subscription period. As one illustration, a new medical services item may become available that is particularly useful in treating a particular infectious condition that may likely arise upon the occurrence of a particular kind of civilly-catastrophic event. In such a case, maintaining such resources can readily accommodate updating the acquired and stored items to include a supply of this new medical services item.

Accordingly, this step of making adjustments can readily comprise one or more of removing a particular one of the stored medical services items (as when a better substitute becomes available, when the stored medical services item itself is shown to be less effective for its intended purpose than was originally thought, and so forth), adding additional ones of the stored medical services items (as when it becomes subsequently understood that more of a particular item is desirable to achieve a particular diagnostic, therapeutic, or treatment goal or purpose), adding at least one new stored medical services item that is not already stored (as illustrated in the example provided above), and so forth.

In the examples provided above, the resource being acquired and maintained comprises consumable or non-consumable medical services items. As noted earlier, however, these teachings are applicable for use with other resources as well. For example, maintaining the resource may relate to also providing civilly-catastrophic event-based access to a specific medical service center (or centers) where provision of such medical services can be securely ensured. By this approach, therefore, this step of maintaining readiness of the medical service can comprise providing and maintaining such a medical service center. As a general principle, given that the ability to provide such services following a civilly-catastrophic event, it may be useful or desirable to configure such a medical service center as, or within the confines of, a shelter that is hardened against the circumstances as may attend such an event.

Much is known in the art regarding construction and maintenance of such shelters. Such a construction will usually at least serve to protect the inhabitants their supplies from environmental stress and extremes. In addition to walls and a roof such a shelter will typically also comprise internal temperature control, lighting, storage facilities, sleeping facilities, food preparation facilities, personal hygiene facilities, and so forth. For present purposes such a shelter may also be equipped to provide for water treatment (such as filtering, bacteria removal, and so forth), waste treatment and/or recycling, electrical power generation, and/or air treatment (including but not limited to conditioning, filtering, and so forth). By one approach such a shelter can also be equipped with communication facilities including a variety of wireless broadcast capabilities, long-distance two-way communications capabilities, and so forth.

And, of course, such a shelter can also comprise appropriate medical services facilities. These can comprise space, equipment, and other operational needs as may be necessary or useful to preserve and/or facilitate the offering of such medical services. This can include, but is not limited to, diagnostic equipment and supplies, medical procedure facilities (including surgical theaters), recovery facilities, laboratories, pharmaceutical storage facilities, reference materials, and meeting and personal accommodation space and facilities for the medical services personnel themselves.

By yet another approach, such a facility can provide private safe deposit box service for the authorized beneficiaries. This, in turn, would permit beneficiaries to pre-provision such a shelter with certain personal items of their choice and/or to have a safe place to store their own valuables upon arriving at the shelter during times of need.

Security will likely comprise a primary concern for such a medical service center. In particular it will likely be important to secure the medical service center, any medical service items as are stored or otherwise available at the shelter, and the inhabitants of the medical service center from unauthorized entry and access. By one approach, this can comprise maintaining the medical service center in a location that is substantially distal from a nearest substantial human population. For example, and referring momentarily to FIG. 4, within a given geographic region 401 (such as a continent, country, or the like) a medical service center 402 may be separated from the closest major population bases 403 by a distance that at least exceeds some predetermined substantial distance X 404. Depending upon other factors, this distance X might comprise, for example, 800 kilometers. Other factors might well play a part in this regard, of course. For example, a significant natural barrier (such as a large mountain range) might lie between a major population base and a medical service center and make reasonable a shorter separation distance between such entities.

When possible, and with continued reference to FIG. 4, it may be desirable to locate such a medical service center 402 in relative proximity to a water source 405. A suitable water source 405 can comprise a ground-level water source or an underground water source as, in either case, ready access to the water source may be available. This, in turn, can be useful with respect to ensuring an adequate supply of water for the inhabitants of the medical service center 402 in times of need. A ground-level water source may also provide a means of ingress and egress to facilitate the comings and goings of the authorized beneficiaries (for example, a navigable waterway can provide an effective pathway by which to transport authorized beneficiaries to the medical service center 402).

Notwithstanding that it may be desirable to locate such medical service centers at a considerable distance from major population centers, this does not necessarily require that such medical service centers be secreted within completely primitive and/or wild settings. For example, one useful approach might be to locate such a medical service center 406 proximal to an entertainment destination 407 (such as, but not limited to, remotely located golf courses, resorts, dude ranches, casinos, and so forth). In such a case at least some of the infrastructure that may be required and/or useful for the medical service center can be shared with the facilities of the entertainment destination and thereby reduce the effective costs of installing and maintaining such facilities.

For a variety of reasons it may be appropriate to provide a plurality of such medical service centers in various locations throughout a relatively wide geographic region such as a continent or country. Such a dispersal can aid with reducing the logistic difficulties of transporting authorized beneficiaries to such a medical service center during times of need. Dispersed medical service centers can also help ensure that at least some medical service centers will more likely survive civilly-catastrophic events that pose sufficient destructive force to destroy an unfortunately located medical service center.

When providing a plurality of medical service centers, it may also be useful to differentiate such medical service centers from one another with respect to, for example, their features and/or accouterments. Such medical service centers may be differentiated, for example, with respect to their relative support for such things as a maximum supportable population, a depth and breadth of provided accouterments of life, specifically provided medical facilities (such as, but not limited to, specialized equipment such as respirators, dialysis equipment, operating facilities, and so forth), pet animal accommodations, risk threat abatement capability, entertainment facilities, and so forth. Assignment and/or access to a given differentiated medical service center can be determined, at least in part, by such things as relative initial proximity of the authorized beneficiary, the terms and conditions of the corresponding subscription agreement, and so forth.

By one approach these teachings can be simply practiced by provision of medical service center and/or medical service item supplies; gaining physical access to such resources comprises the responsibility of the authorized beneficiaries. During such times, of course, it can be expected that civil conditions will be troubled and confusing. Therefore, by another approach these teachings can further encompass transporting at least some of the authorized beneficiaries to the medical service center and/or supplies in response to the occurrence of a civilly-catastrophic event. There are various ways by which to accomplish such a task.

Referring still to FIG. 4, by one optional approach at least one rally point 608 can be identified 502. Such a rally point need not be reserved only for this purpose and may, for example, simply comprise a convenient location for at least some authorized beneficiaries. Example rally points might include sports stadiums and auditoriums, amusement parks, and the like. When possible, it may be helpful to locate such a rally point relatively near an airstrip and/or a navigable waterway. Such amenities, in turn, can potentially be used when transporting the gathered beneficiaries to their destination (as when, for example, a destination medical service center is accessible from the navigable waterway that is also readily accessible from the rally point).

By one approach, one or more such rally points can be identified for each larger population area that contains authorized beneficiaries. It would also be possible, of course, to identify rally points to serve a similar function in more rural settings as well if desired.

This process can then optionally provide information regarding such rally points to the authorized beneficiaries. This information can be provided prior to the occurrence of a civilly-catastrophic event if desired. It may also be useful or possible to provide such information (either in the first instance or as a supplemental notice) following the initiation of such an event. The latter may be achieved using such communication means as may be available at the time. It would also be possible to provision each authorized beneficiary (or family or company of beneficiaries) with one or more communications devices by which such information could be provided. This process could then provide appropriate transportation to move the authorized beneficiaries from these rally points to the destination (such as to a designated medical service center).

In many instances such transportation can comprise standard vehicles (cars, buses, boats, airplanes, railroad cars, and so forth). If desired, however, more specialized equipment could be used including but not limited to armored transports, environmentally-contained vehicles or trailers, and so forth.

These teachings can readily accommodate other features as well. For example, prior to the occurrence of a civilly-catastrophic event an authorized beneficiary can be provided 103 with an emergency medical services kit to facilitate their survival prior to their being able to access the aforementioned medical services upon the occurrence of a civilly-catastrophic event. Such an emergency medical services kit might comprise, for example, a seven day (or other desired duration) supply of first aid supplies, drugs having potential particular use with respect to specific kinds of civilly-catastrophic events, and so forth.

As another example, authorized beneficiaries could be provided 104 with a medical service instruction guide kit. These instructions could provide information regarding use of certain medically relevant commonly available items, proper use of the contents of the aforementioned emergency medical services kit, first aid instructions, emergency responses, and so forth.

This medical service instruction guide kit could comprise, for example, a book or manual having printing survival instructions and information in combination with fill-in-the-blank opportunities whereby a given authorized beneficiary could customize the instructions to specifically suit their particular needs and situation. Such blanks could be used, for example, to prompt the beneficiary to think through and to record information such as their specific therapeutic regimens, medical requirements to be observed during travel, and so forth. Such a book or manual could include indexes, tabs, or other navigation tools to permit a reader to quickly find the relevant information they require during a time of need.

These teachings would also accommodate providing 105 medical service training to authorized beneficiaries. Such training could comprise in-person, on-site training, live instructors, and/or previously prepared teaching resources such as, but not limited to, electronic learning resources. This training could include both general information regarding specific medical services do's and don'ts as pertain to different kinds of civilly-catastrophic events as well as more specific information regarding specific actions that should be taken by the authorized beneficiary with respect to successfully achieving access to their subscribed-to medical services as per their subscription.

In many cases a given individual's medical history can be important with respect to ensuring proper present care. This process 100 will therefore also optionally provide for receiving 106 medical records for a given authorized beneficiary and maintaining 107 the availability of those medical records pending a need to permit subscription-based access to the aforementioned medical services in the event of a civilly-catastrophic event. By pre-positioning such medical records, the beneficiary may be better assured that such information will be readily available in a time of need.

These teachings can then of course provide for confirming 108 the occurrence of a triggering civilly-catastrophic event and responsively then permitting subscription-based access 109 to these previously arranged and maintained medical services. This may comprise, if desired, use of a mechanism that the beneficiary carries with them to confirm their authorized status in this regard. This mechanism can comprise personal property (such as an identification card) or can comprise, for example, a biometric-based identity authentication process that relies upon fingerprints, retinal patterns, or some other relatively unique aspect of the human body.

It will be appreciated that these teachings provide for a highly flexible yet powerfully effective way by which a modern citizen can greatly improve their likelihood of receiving necessary or helpful medical services following a civilly-catastrophic event. These teachings are sufficiently flexible so as to accommodate the needs and desires of a wide-ranging set of potential beneficiaries. Via these teachings the authorized beneficiaries can improve their ability to access medical services during times of great societal stress notwithstanding society's ability, in general, to assure such services under these same conditions.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
accepting consideration-based private civil security subscriptions from subscribers with respect to providing civilly-catastrophic event-based access to at least one life-sustaining medical service;
maintaining readiness of the at least one life-sustaining medical service pending a need to permit subscription-based access to the at least one life-sustaining medical service in event of a civilly-catastrophic event.

2. The method of claim 1 wherein accepting consideration-based private civil security subscriptions from subscribers comprises accepting the consideration-based private civil security subscriptions at a for-profit business.

3. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

4. The method of claim 1 wherein accepting consideration-based private civil security subscriptions from subscribers with respect to providing civilly-catastrophic event-based access to at least one life-sustaining medical service comprises accepting consideration-based private civil security subscriptions from subscribers with respect to providing civilly-catastrophic event-based access to a plurality of different life-sustaining medical services.

5. The method of claim 1 wherein the at least one life-sustaining medical service comprises at least one of:
an acute need medical service;
a chronic need medical service;
a diagnostic medical service;
a medical treatment;
a medical procedure;
a life support service;
at least a portion of a series of related medical treatments;
an apparatus-based medical service;
a human-skills-based medical service;
extended care accommodations.

6. The method of claim 1 wherein the civilly-catastrophic event comprises an event that substantially disrupts society's infrastructure and ability to provide the at least one medical service.

7. The method of claim 6 wherein the civilly-catastrophic event is one that persists in substantial form for more than a predetermined period of time.

8. The method of claim 6 wherein the civilly-catastrophic event comprises at least one of:
a natural disaster;
a human-caused disaster.

9. The method of claim 8 wherein the natural disaster comprises at least one of:
an extreme weather-related event;
an extreme geological event;
an extreme space-based collision;
an extreme environmental event;
a pandemic.

10. The method of claim 8 wherein the human-caused disaster comprises at least one of:
a nuclear-related event;
an act of war;
a release of a dangerous biological agent;
a release of a dangerous chemical agent.

11. The method of claim 1 wherein the at least one life-sustaining medical service comprises at least one of:
material that is at least substantially consumed during ordinary usage;
material that is not at least substantially consumed during ordinary usage.

12. The method of claim 1 wherein accepting consideration-based private civil security subscriptions from subscribers with respect to providing civilly-catastrophic event-based access to at least one life-sustaining medical service further comprises accepting consideration-based private civil security subscriptions from subscribers with respect to providing civilly-catastrophic event-based access to at least one life-enhancing medical service that does not necessarily comprise a life-sustaining medical service.

13. The method of claim 12 wherein the at least one life-enhancing medical service comprises a plurality of different life-enhancing medical services.

14. The method of claim 12 wherein the at least one life-enhancing medical service comprises at least one of:
an acute need medical service;
a chronic need medical service;
a diagnostic medical service;
a medical treatment;
a medical procedure;
at least a portion of a series of related medical treatments;
an apparatus-based medical service;
a human-skills-based medical service.

15. The method of claim 1 wherein accepting consideration-based private civil security subscriptions from subscribers with respect to providing civilly-catastrophic event-based access to at least one life-sustaining medical service comprises accepting consideration-based private civil security subscriptions from subscribers with respect to providing civilly-catastrophic event-based access to at least a predetermined quantity of the at least one life-sustaining medical service.

16. The method of claim 15 wherein the predetermined quantity comprises a one year's supply of the at least one life-sustaining medical service.

17. The method of claim 15 wherein the predetermined quantity is determined as a function of a particular course of treatment to thereby ensure that a given subscription beneficiary will be able to complete the particular course of treatment should that particular course of treatment be interrupted by the civilly-catastrophic event.

18. The method of claim 1 wherein accepting consideration-based private civil security subscriptions from subscribers with respect to providing civilly-catastrophic event-based access to at least one life-sustaining medical service comprises providing a plurality of differentiated subscription opportunities that correspond to differing life-sustaining medical service offerings.

19. The method of claim 18 wherein the differentiated subscription opportunities differ from one another at least with respect to cost.

20. The method of claim 1 wherein accepting consideration-based private civil security subscriptions from subscribers with respect to providing civilly-catastrophic event-based access to at least one life-sustaining medical service comprises accepting consideration-based private civil security subscriptions from subscribers with respect to providing civilly-catastrophic event-based access by predetermined authorized beneficiaries to at least one life-sustaining medical service.

21. The method of claim 20 wherein maintaining readiness of the life-sustaining medical service pending a need to permit subscription-based access to the life-sustaining medical service in event of a civilly-catastrophic event comprises storing corresponding non-human resources to provide stored necessities that are held on behalf of the authorized beneficiaries pending a need to provide the life-sustaining medical service upon occurrence of the civilly-catastrophic event.

22. The method of claim 21 wherein maintaining readiness of the life-sustaining medical service pending a need to permit subscription-based access to the life-sustaining medical service in event of a civilly-catastrophic event comprises arranging for availability of proficient human resources capable of providing the at least one life-sustaining medical service pending a need to provide the life-sustaining medical service upon occurrence of the civilly-catastrophic event.

23. The method of claim 22 wherein the proficient human resources comprise at least one of:
a physician;
a surgeon;
a medical technician;
a radiologist;
a laboratory technician;
a nurse;
an emergency response technician;
a pharmacist;
a chiropractor;
an optician;
an anesthesiologist;
a psychologist;
a naturopathic practitioner.

24. The method of claim 21 wherein accepting consideration-based private civil security subscriptions from subscribers with respect to providing civilly-catastrophic event-based access to at least one life-sustaining medical service further comprises accepting consideration-based private civil security subscriptions from subscribers with respect to providing civilly-catastrophic event-based transport service.

25. The method of claim 24 wherein accepting consideration-based private civil security subscriptions from subscribers with respect to providing civilly-catastrophic event-based access to at least one life-sustaining medical service further comprises accepting consideration-based private civil security subscriptions from subscribers with respect to providing civilly-catastrophic event-based rescue service.

26. The method of claim 1 wherein:
maintaining readiness of the at least one life-sustaining medical service pending a need to permit subscription-based access to the life-sustaining medical service in event of a civilly-catastrophic event comprises:
acquiring at least one corresponding predetermined consumable medical services necessity to provide acquired necessities;
storing the acquired necessities to provided stored necessities that are held on behalf of the authorized beneficiaries pending a need to provide the life-sustaining medical service in event of the civilly-catastrophic event.

27. The method of claim 26 wherein maintaining readiness of the at least one life-sustaining medical service further comprises managing the stored necessities to facilitate at least one of:
maintaining utility of the stored necessities;
making adjustments to the stored necessities to reflect dynamically changing circumstances as occur during the consideration-based private civil security subscription.

28. The method of claim 27 wherein making adjustments to the stored necessities comprises at least one of:
removing a particular one of the stored necessities;
adding additional ones of the stored necessities;
adding at least one new stored necessity that is not already stored.

29. The method of claim 1 wherein maintaining readiness of the at least one life-sustaining medical service pending a need to permit subscription-based access to the life-sustaining medical service in event of a civilly-catastrophic event comprises:
monitoring likelihoods that particular civilly-catastrophic events will occur;
adjusting the at least one life-sustaining medical service as a function, at least in part, of such likelihoods.

30. The method of claim 29 wherein adjusting the at least one life-sustaining medical service as a function, at least in part, of such likelihoods comprises at least one of:
increasing a stored supply of a particular item of medical services equipment;
increasing availability of a particular area of medical services expertise;
increased a stored supply of a particular item of medical services consumable;
reducing a stored supply of a particular item of medical services equipment;
reducing availability of a particular area of medical services expertise;
reducing a stored supply of a particular item of medical services consumable;
establishing an initial stored supply of a particular item of medical services equipment;
establishing initial availability of a particular area of medical services expertise;
establishing an initial stored supply of a particular item of medical services consumable.

31. The method of claim 26 wherein storing the acquired necessities comprises storing the acquired necessities at a secure facility.

32. The method of claim 31 wherein storing the acquired necessities at a secure facility comprises, at least in part, storing the acquired necessities at a secure facility that is substantially distal from a substantial human population.

33. The method of claim 32 wherein storing the acquired necessities at a secure facility that is substantially distal from a substantial human population further comprises storing the acquired necessities at a secure facility that is proximal to an entertainment destination.

34. The method of claim 26 wherein storing the acquired necessities to provided stored necessities comprises storing the stored necessities in bundles on a subscriber-by-subscriber basis.

35. The method of claim 34 wherein the bundles are palletized.

36. The method of claim 26 wherein storing the acquired necessities to provided stored necessities comprises storing the stored necessities using storage facilities that are located at least a substantial distance from one another.

37. The method of claim 26 further comprising:
providing to the authorized beneficiaries, prior to the civilly-catastrophic event, an emergency medical services kit to facilitate survival of the authorized beneficiaries prior to their being provided the life-sustaining medical service following initiation of the civilly-catastrophic event.

38. The method of claim 26 further comprising:
providing to the authorized beneficiaries, prior to the civilly-catastrophic event, a medical service instruction guide kit.

39. The method of claim 38 wherein the medical service instruction guide kit comprises, at least in part, a hardcopy manual containing instructions to be observed by the authorized beneficiaries.

40. The method of claim 39 wherein the hardcopy manual further comprises information blanks to be filled in by the authorized beneficiaries to thereby personalize the medical service instructions with specific information relevant to the medical service needs of individual authorized beneficiaries.

41. The method of claim 26 further comprising:
providing to the authorized beneficiaries, prior to the civilly-catastrophic event, medical service training.

42. The method of claim 41 wherein providing the medical service training comprises, at least in part, providing the authorized beneficiaries with access to electronic learning resources.

43. The method of claim 1 wherein maintaining readiness of the at least one life-sustaining medical service pending a need to permit subscription-based access to the at least one life-sustaining medical service in event of a civilly-catastrophic event comprises not permitting substantial access to the at least one life-sustaining medical service absent the civilly-catastrophic event.

44. The method of claim 1 further comprising:
receiving medical records for at least one authorized beneficiary;
maintaining availability of the medical records pending a need to permit subscription-based access to the at least one life-sustaining medical service in event of a civilly-catastrophic event, such that the medical records are pre-positioned for use when providing the access.
